(19) United States
(12) Patent Application Publication
(10) Pub. No.: US 2002/0196630 A1
(43) Pub. Date: Dec. 26, 2002

(54) Decoration lamp assembly

(76) Inventor: Shih-Chang Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/885,035

(22) Filed: Jun. 21, 2001

(51) Int. Cl. F21V 3/00

(52) U.S. Cl. 362/351; 362/363; 362/554; 362/806

(57) ABSTRACT

A decoration lamp assembly includes a decoration cover having an opening defined in a bottom thereof and an engaging sleeve has a it end thereof engaged with the aperture. The engaging sleeve has a narrower second end and a lamp is engaged with the engaging sleeve and held by the second end of the engaging sleeve.

### FIELD OF THE INVENTION

The present invention relates to a decoration lamp assembly and more particularly, to a Christmas lamp assembly that allows two different sizes of bulb to be received therein.

### BACKGROUND OF THE INVENTION

A conventional Christmas lamp assembly generally includes a long wire with a plurality of lamps connected thereto and each of the lamps includes a frame and a lamp shell fixedly mounted on the frame. The lamp shells have desired colors so that when the electrical power is connected, the lamps turn on and present different colors. All of the lamp shells are fixed to the respective frames so that they cannot be replaced and the specification of the lamps cannot be changed. A latest decoration lamp is developed and has a replaceable lamp which is snapped in a frame. However, such structure is not suitable for those lamps that have larger amperages.

### SUMMARY OF THE INVENTION

In accordance with one aspect of the present invention, there is provided a decoration lamp assembly which comprises a decoration cover having an opening defined in a bottom thereof and an engaging sleeve has a first end thereof engaged with the aperture. A second end of the engaging sleeve is located in the cover and is narrower than that of the first end of the engaging sleeve. A lamp is engaged with the engaging sleeve.

The primary object of the present invention is to provide a decoration lamp assembly wherein two different types of lamps can be connected to the decoration cover of the assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a decoration lamp assembly of the present invention;

FIG. 2 is a cross sectional view to show a fir lamp is engaged with a sleeve in the cover of the present invention;

FIG. 3 is a cross sectional view to show a second lamp is directly engaged with the cover of the present invention;

FIG. 4 is an exploded view to show a second embodiment of the decoration lamp assembly of the present invention;

FIG. 5 is a cross sectional view to show the cover with the engaging sleeve of the second embodiment of the present invention; and

FIG. 6 is a cross sectional view to show a lamp is held by the engaging sleeve of the second embodiment of the present invention.

### DETAILED DESCRIPTION OF THE PREFERRED EMBODIMENT

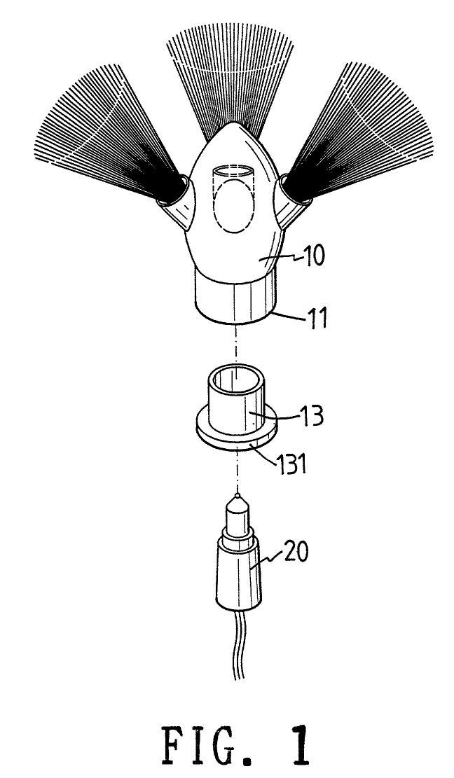

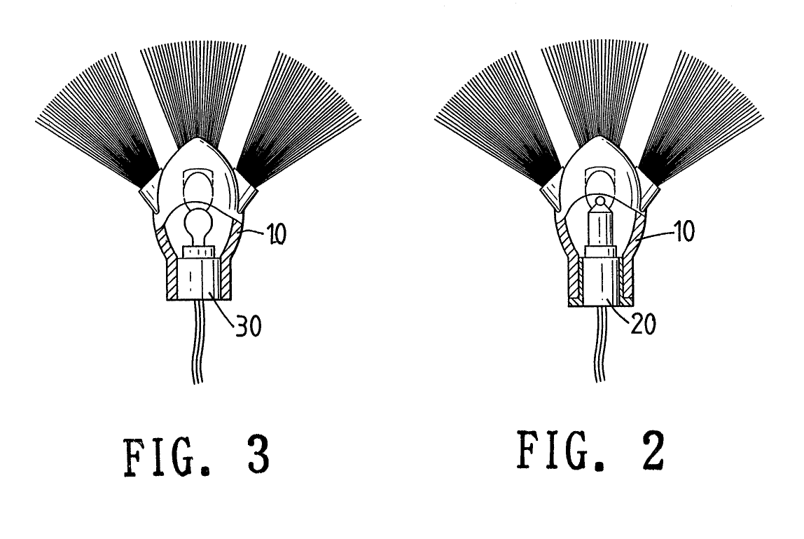

Referring to FIGS. 1 and 2, the decoration lamp assembly of the present invention comprises a decoration cover 10 having an opening 11 defined in a bottom thereof and a sleeve 13 is removably engaged with the aperture 11. The sleeve 13 has a flange 131 so as to be engaged with the bottom of the cover 10. A lamp 20 extends through the sleeve 13 and engaged with the sleeve 13. If a larger amperage lamp 30 is to be engaged with the cover 10 as shown in FIG. 3, the sleeve 13 is removed from the cover 10 and the lamp 30 can be directly engaged with the aperture 11 of the cover 10. By this way, the cover 10 can accommodate two types of lamps 20, 30.

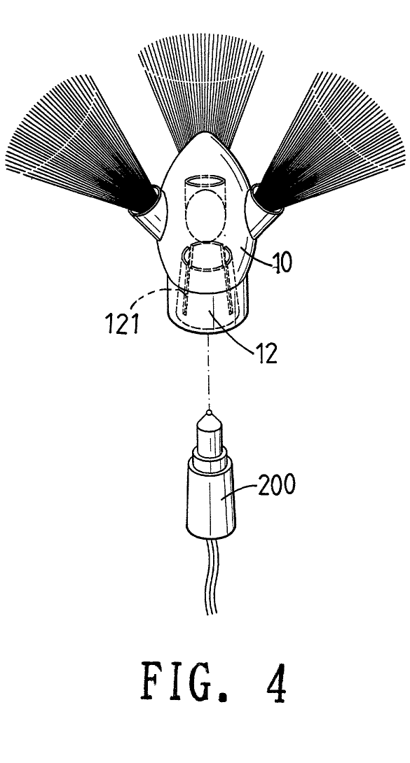

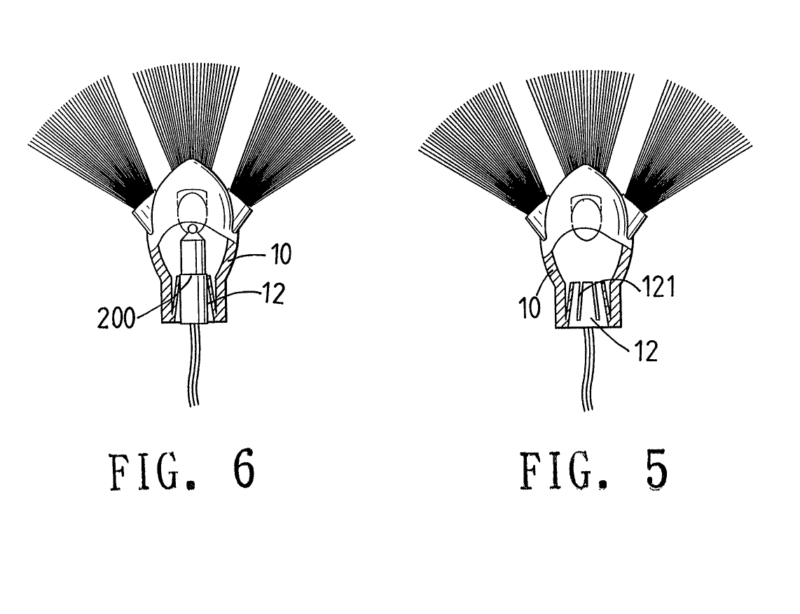

Referring to FIGS. 4 to 6, a second embodiment of the present invention is that the decoration cover 10 has an opening 11 defined in a bottom thereof and an engaging sleeve 12 has a first end thereof engaged with the aperture 11. A second end of the engaging sleeve 12 is located in the cover 10 and is narrower than that of the first end of the engaging sleeve 12. A plurality of slits 121 are defined longitudinally in the second end of the engaging sleeve 12 so that the second end of the engaging sleeve 12 has an expandable feature and a lamp 200 can be held by the second end of the engaging sleeve 12.

While we have shown and described the embodiment in accordance with the present invention, it should be clear to those skilled in the art that further embodiments may be made without departing from the scope of the present invention.

What is claimed is:

1. A decoration lamp assembly comprising:
a decoration cover having an opening defined in a bottom thereof and a sleeve removably engaged with said aperture, and
a lamp extending through said sleeve and engaged with said sleeve.

2. A decoration lamp assembly comprising:
a decoration cover having an opening defined in a bottom thereof and an engaging sleeve having a first end thereof engaged with said aperture, a second end of said engaging sleeve located in said cover and being narrower than that of said first end of said engaging sleeve, and
a lamp engaged with said engaging sleeve.

3. The lamp assembly as claimed in claim 2 wherein a plurality of slits are defined longitudinally in the second end of the engaging sleeve.
